(19) United States
(12) Patent Application Publication
(10) Pub. No.: US 2014/0371987 A1
(43) Pub. Date: Dec. 18, 2014

(54) RECONFIGURABLE STEERING WHEEL WITH VISUAL FEEDBACK RELATED TO VEHICLE SYSTEMS

(71) Applicant: FORD GLOBAL TECHNOLOGIES LLC, DEARBORN, MI (US)

(72) Inventor: John Rober Van Wiemeersch, Novi, MI (US)

(73) Assignee: FORD GLOBAL TECHNOLOGIES LLC, DEARBORN, MI (US)

(21) Appl. No.: 14/170,757

(22) Filed: Feb. 3, 2014

Related U.S. Application Data
(60) Provisional application No. 61/792,431, filed on Mar. 15, 2013.

(51) Int. Cl. B62D 1/04; G06F 3/01

(52) U.S. Cl. CPC B62D 1/04; G06F 3/01
USPC 701/41

(57) ABSTRACT

An automotive vehicle steering wheel having at least one touch screen display associated therewith is disclosed. The touch screen display is configured to: (i) display interactive icons, each indicative of an associated vehicle functionality, (ii) receive selective input from a vehicle driver touching the icons to control said associated functionality; and (iii) selectively display passive information directed to the operation of the vehicle.

### CROSS-REFERENCE TO RELATED APPLICATIONS

This application claims the benefit of U.S. provisional application Ser. No. 61/792,431 filed Mar. 15, 2013 which is incorporated herein by reference in its entirety.

### BACKGROUND

For a number of years, it has been common to locate functional buttons or switches on steering wheels of automotive vehicles. These functional buttons have typically been physical buttons or switches, each having a single function assigned to it. For example, it has been fairly common for vehicle steering wheels to include buttons or switches that control such features as radio presets, radio volume, cruise control settings, temperature and fan settings, and the like. Over time, there has been a trend toward locating more and more vehicle functions on the vehicle steering wheel. This approach is both convenient for the driver and enhances safety, as a driver is more inclined to keep his/her eyes on or closer to the road while adjusting vehicle settings.

The addition of many functional buttons and switches to the surface of vehicle steering wheels has provided the above stated benefits but has also created problems. The limited area on the steering wheel surface limits the number of buttons and switches that can be added to the steering wheel, at least where the traditional approach of assigning a single function to each button or switch is employed. Further, when the surface of a steering wheel becomes crowded with buttons, it becomes difficult for a driver to navigate all of the different buttons/switches and functions, which diminishes the convenience and safety of having the functionality on the surface of the steering wheel in the first place. Further, depending on the customer and their driving patterns, some of the fixed wheel buttons may never be used (ex., speed control) and are just wasting space that could be used for other function switches more to their preference.

To address the overcrowding issue, some vehicle steering wheels use programmable “soft” buttons, which can be selectively programmed to control different functions of the vehicle. For example, a single programmable button could control the radio volume or the cabin temperature, depending on the selected mode of the button. Some programmable “soft” buttons for vehicle steering wheels have been implemented through one or more touch screens displays mounted in or on the steering wheel surface.

While touch screen displays can adequately increase the number of functions that can be implemented on a vehicle steering wheel in a limited surface area, the inventor of the embodiments described hereinafter has recognized that the touch screens on a vehicle steering wheel do not need to always display functional buttons or switches, but, instead can also provide various feedback information to the driver.

### SUMMARY

An automotive vehicle steering wheel having at least one touch screen display associated therewith is disclosed. The touch screen display is configured to: (i) display interactive icons, each indicative of an associated vehicle functionality, (ii) receive selective input from a vehicle driver touching the icons to control said associated functionality; and (iii) selectively display passive information directed to the operation of the vehicle.

### BRIEF DESCRIPTION OF DRAWINGS

FIG. 1 is an illustration of an exemplary automotive vehicle having a steering wheel of one of the described embodiments.

FIG. 2 is a front view of a steering wheel having two touch screen displays disposed thereon.

FIG. 3a is a front view of the steering wheel of FIG. 2, each touch screen display displaying multiple icons.

FIG. 3b is a front view of the steering wheel of FIG. 2, a portion of the first touch screen display showing passive feedback information in graphical form.

FIG. 3c is a front view of the steering wheel of FIG. 2, a portion of the second touch screen display showing passive feedback information in graphical form.

FIG. 3d is a front view of the steering wheel of FIG. 2, a portion of the first touch screen display showing passive feedback information in a word message.

FIG. 3e is a front view of the steering wheel of FIG. 2, a portion of the first touch screen display showing passive feedback information in a graphical form.

### DETAILED DESCRIPTION

A vehicle steering wheel having at least one touch screen display disposed on the surface of the steering wheel is disclosed. The touch screen display(s) is programmable to selectively display a variety of icons, such as “buttons” or “switches” or the like, that enable the driver to control various vehicle systems. In addition, the touch screen displays provide a variety of feedback information to the driver, including for instance information concerning the current operation of the various vehicle and/or vehicle subsystems, the current driving condition of the vehicle and/or various alerts to the driver.

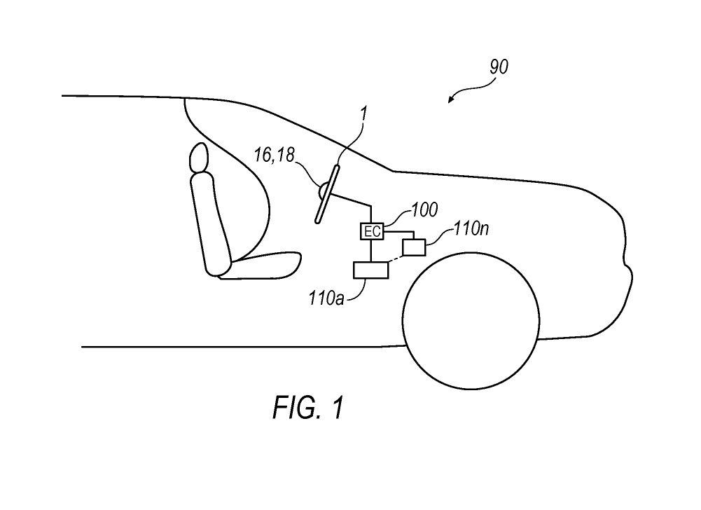

FIG. 1 illustrates an exemplary vehicle environment in which the steering wheel embodiments may be used. Vehicle 100 includes an electronic controller (EC) 100. The electronic controller 100 is communicatively coupled to various sensors and devices 110a through 110n located in the vehicle for providing feedback information and other data concerning the state of the vehicle and/or vehicle subsystems to the electronic controller 100. The electronic controller 100 is also communicatively coupled to the steering wheel 1, which includes one or more touch screen displays 16, 18 disposed on or coupled to the steering wheel 1 in such a manner as to be visible to the vehicle driver.

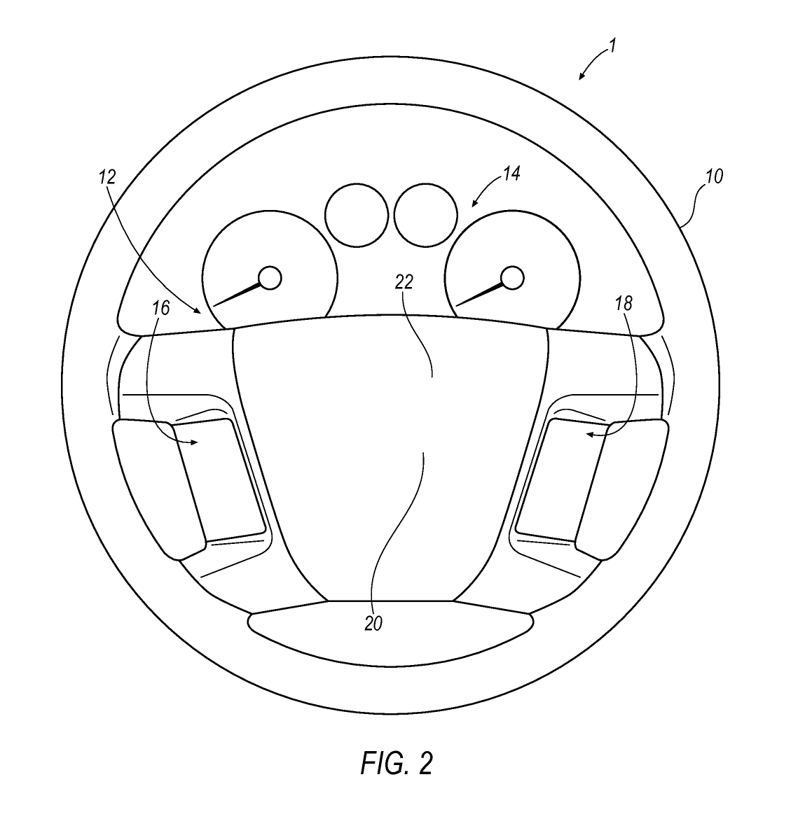

FIG. 2 illustrates a front view of the exemplary steering wheel 1 for an automotive vehicle 100, according to one embodiment. The steering wheel 1 includes the outer wheel 10 and an interior area 12. Within the interior area 12 of the outer wheel 10 are various common components, such as the horn 20 and airbag 22. The upper half of the interior area 12 is commonly left void so as to permit a driver to see through to the instrument cluster 14. Also included in the interior area 12 of the outer wheel 10 are two touch screen displays 16, 18. The touch screen displays 16 and 18 are of known type, and they can be of any size and shape, provided that they are coupled to, disposed on or integrated with, or otherwise associated with, the steering wheel in such a manner as to visible to the driver during normal driving conditions. In other embodiments, there may be one touch screen display or any other number of touch screen displays that are desirable and/or appropriate for the physical configuration of the steering wheel 1. The touch screen displays are controlled by electronic controller 100 (shown in FIG. 1). The touch screens 16, 18 may also adopt various strategies to mitigate inadvertent activation of the soft switches while turning which are not a subject of this invention.

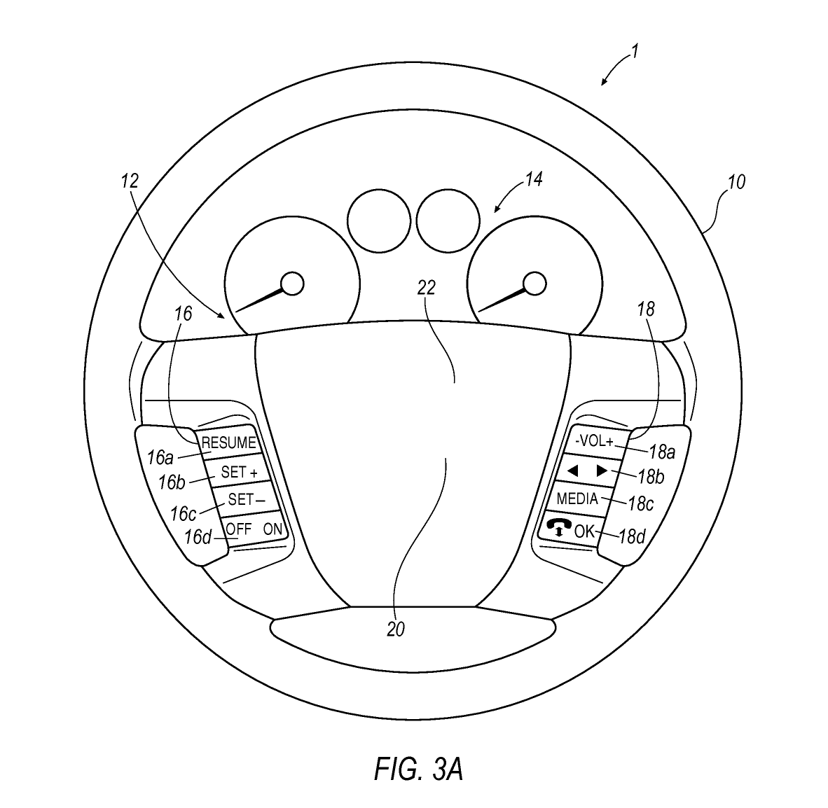

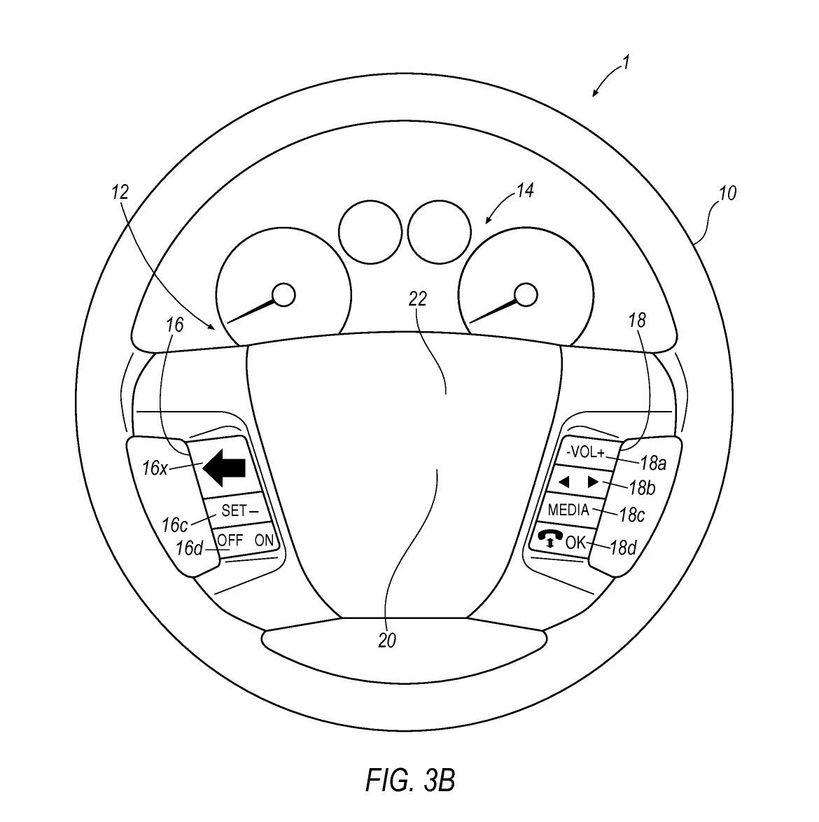

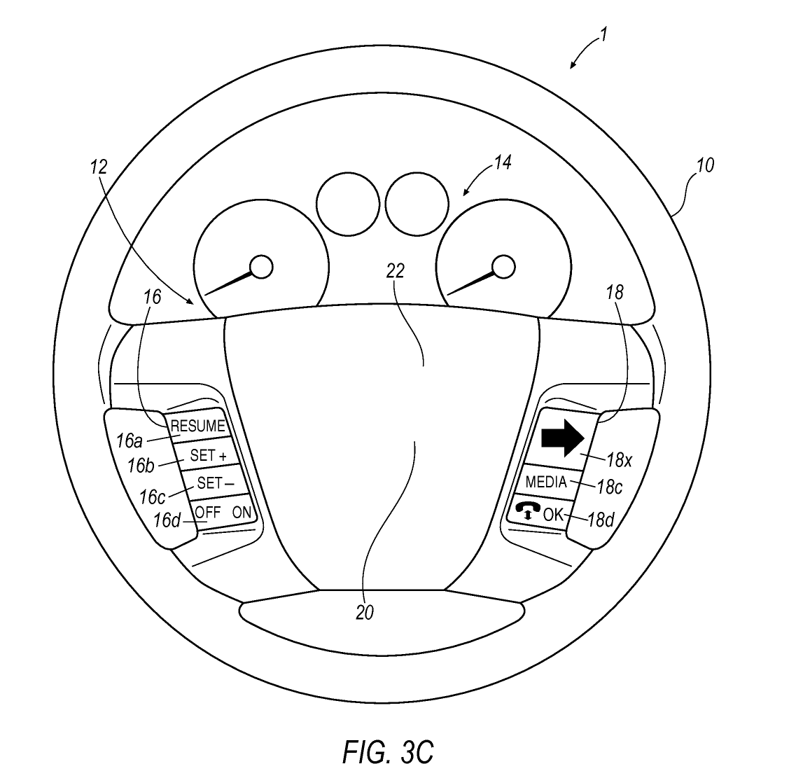

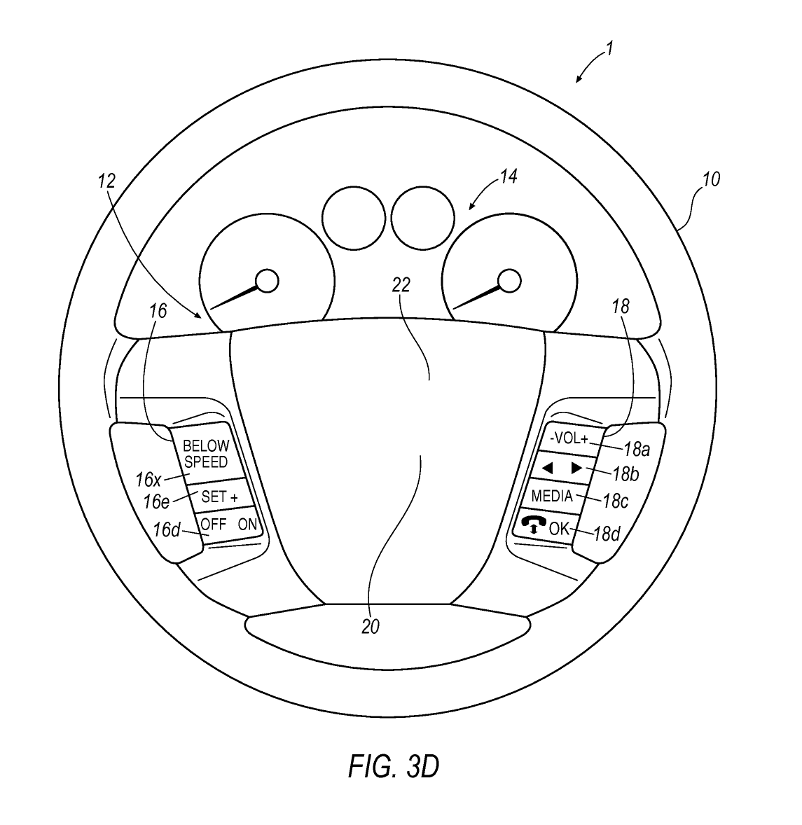

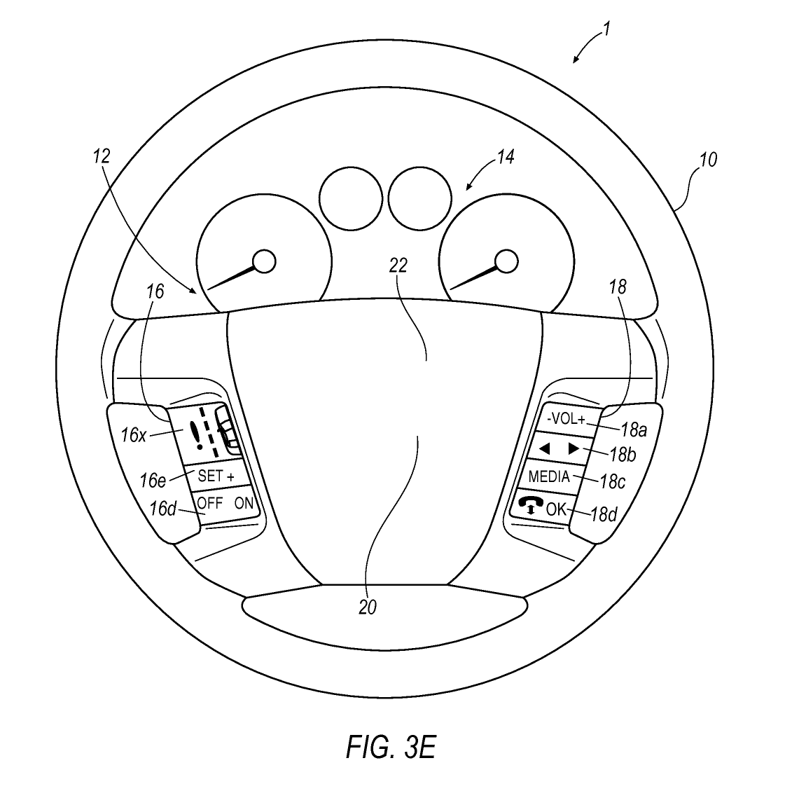

As shown in FIG. 3a, the touch screen displays 16 and 18 are configured to display interactive “buttons”, “switches” or other interactive icons (collectively, “icons”, “buttons”, or “switches”) to the user, which the user can select or actuate by touching with a finger to control various subsystems and functions of the vehicle. The “icons” are shown in FIG. 2a as icons 16a-16d and 18a-18d. The “icons” may be of any shape, size or configuration on the touch screen display(s), provided that they offer the driver an area on the touch screen display 16 or 18 to provide touch input to control an associated subsystem or function of the vehicle. The trim lines separating the soft buttons may be soft scribed into the screen surface filters or generated by the display itself. The touch screen displays 16 and 18 are configurable to display different “icons” associated with different vehicle controls at different times, at the direction of the vehicle driver and/or automatically in response to various vehicle performance conditions. For example, touch screen display 16 shows four “icons” in FIG. 3a, namely “Resume” 16a, “Set +” 16b, “Set −” 16c, and “Off On” 16d, which all allow the user to provide input to control various aspects of the vehicle's speed control functionality. Similarly, touch screen display 18 shows four “icons” in FIG. 3a, namely “− Vol +” 18a, “<>” 18b, “Media” 18c, and “<phone symbol> OK” 18d, which all relate to controlling aspects of the vehicle's entertainment and cellular communications functions. These “icons” can be changed at the direction of the vehicle driver or in response to vehicle performance conditions to “icons” that are associated with and control other aspects of the vehicle. In this manner, a relatively large number of vehicle control functions can be made available to the driver on the vehicle steering wheel within a relatively limited amount of surface area on the interior area 12 of the steering wheel 1.

In addition to displaying functional “icons” that interactively permit the vehicle driver to provide control input, the touch screen displays 16 and 18 are also configured to display passive feedback to the vehicle driver directed to the performance, condition or other aspect of the vehicle or driving condition. For example, FIGS. 3b-3e illustrate examples of situations where portions of one of touch screen displays 16 or 18 are used to provide passive feedback information to the vehicle driver in place of one or more of the interactive “icons”. FIG. 3b illustrates the same steering wheel 1 and touch screen displays 16 and 18 as in FIG. 3a. But in FIG. 3b, a portion of the touch screen display 16x shows a blinking arrow symbol, which appears on the touch screen display 16 in place of the “Resume” 16a and “Set +” 16b “icons” shown in FIG. 1. The blinking arrow may be displayed on the touch screen display 16 when the driver has activated a turning signal or “blinker” to indicate an intention to turn the vehicle or change lanes. The blinking arrow may be displayed in white or green under normal conditions and may be displayed in red, for example, if the vehicle's collision avoidance system detects an object in the intended path of the vehicle. The blinking arrow is displayed on the touch screen display 16 in such a manner as to replace “icons” that are unlikely to be used during the current activity of the vehicle. For example, the blinking arrow in FIG. 3b replaces the “Resume” and “Set +” icons (related to the vehicle's speed control functionality) shown in FIG. 3a, which are unlikely to be useful during a time when the vehicle is turning or changing lanes. FIG. 3c similarly illustrates using a portion 18x of the touch screen 18 to display a blinking arrow to indicate that the vehicle's turn signal has been activated. The blinking arrow in FIG. 3c replaces two audio control icons 18a, 18b, which would typically be unused while the vehicle is turning or changing lanes. Additionally, the blinking arrows of display 16 in FIG. 3b and of display 18 in FIG. 3c could be driven simultaneously when the vehicle hazard button has been activated.

FIG. 3d illustrates steering wheel 1 and touch screen displays 16, 18 showing a portion of touch screen 16x as being used to display an alert message to the vehicle driver. In this example, the “Resume” and “Set +” icons 16a and 16b have been replaced by the message “Below Speed”. This replacement would occur when the electronic controller 100 has sensed that the vehicle is below a minimum threshold speed at which speed control functionality is available (most systems will not activate until around 35 mph). In this way, the functionality of the “icons” is disabled and is replaced by an information message to the driver indicating the reason the feature is not available.

FIG. 3e illustrates steering wheel 1 and touch screen displays 16, 18 showing a portion of touch screen 16x as being used to display a graphical alert to the driver. In this example, the “Resume” and “Set +” icons 16a and 16b have been replaced by the graphical illustration of a vehicle leaving a lane and an exclamation point, indicating to the driver that the vehicle is unexpectedly veering from its lane. This message may be displayed on the touch screen when the electronic controller 100 determines, based on input from various sensors, that the vehicle is unexpectedly leaving its lane, such as in known Lane Departure Warning and Lane Keep Assistance subsystems.

The specific embodiments discussed hereinabove can be extended to a variety of applications, which are contemplated by the inventor and intended to be included within the scope of this disclosure. For example, any number of touch screen displays of any particular size and configuration may be used. Further, any variety and number of interactive functional control “icons” may be employed and displayed on the touch screen displays. Further, a wide variety of different passive messages and alerts may be displayed to the user in replacement of the various interactive icons depending upon the various driver and driving conditions, vehicle conditions and other activity of the vehicle. For example, certain exit warnings, such as “Engine Running” or “Shifter Not In Park”, could be displayed as appropriate. The touch screen displays could be illuminated in white for exit/entry assistance. Alternatively, the touch screen displays can be illuminated with a chosen color for ambient lighting.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent upon reading the above description. The scope of the invention should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the invention is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

1. An automotive vehicle steering device, comprising:
a wheel having an interior area;
at least one touch screen display associated with said wheel;
said touch screen display configured to:
display interactive icons, each indicative of an associated vehicle functionality, and to receive selective input from a vehicle driver touching said icons to control said associated functionality; and
selectively display passive information directed to the operation of the vehicle.

2. The automotive vehicle steering device of claim 1, wherein said passive information replaces one or more of said previously-displayed interactive icons.

3. The automotive vehicle steering device of claim 1, wherein said passive information comprises alert messages to the driver.

4. The automotive vehicle steering device of claim 1, wherein said touch screen is positioned in the interior area of the wheel.

5. The automotive vehicle steering wheel of claim 1, wherein said passive information comprises graphical symbols.

6. The automotive vehicle steering wheel of claim 1, wherein said passive information comprises a word message.

7. The automotive vehicle steering wheel of claim 1, wherein said information directed to the operation of the vehicle includes information directed to one of: (i) a state of the vehicle, (ii) the performance of the vehicle, (iii) the physical surroundings of the vehicle, (iv) the condition of the vehicle driver and (v) the state of one or more vehicle subsystems.

8. A method of displaying information to a driver of an automotive vehicle, comprising:
providing a vehicle steering wheel having at least one associated touch screen display that is visible to the vehicle driver;
causing the touchscreen display to display interactive icons associated with vehicle functionality;
causing the touchscreen to convey signals to an electronic controller directed to controlling a function of the vehicle in response to touch input from the vehicle driver;
causing the touchscreen display to selectively display passive information directed to the operation of the vehicle.

9. The method of claim 8, wherein said passive information replaces one or more of said previously-displayed interactive icons.

10. The method of claim 8, wherein said touch screen is positioned in the interior area of the wheel.

11. The method of claim 8, wherein said passive information comprises graphical symbols.

12. The method of claim 8, wherein said passive information comprises a word message.

13. The method of claim 8, wherein said information directed to the operation of the vehicle includes information directed to a state of the vehicle, the performance of the vehicle, the physical surroundings of the vehicle, the condition of the vehicle driver and the state of one or more vehicle subsystems.
